(19) United States
(12) Patent Application Publication
(10) Pub. No.: US 2002/0029720 A1
(43) Pub. Date: Mar. 14, 2002

(54) Road-rail adaptive vehicle transit system

(76) Inventors: Lou Esposito, Boise, ID (US); Rick Tremblay, Boise, ID (US)

Correspondence Address: PEDERSEN & COMPANY, PLLC, P.O. BOX 2666, BOISE, ID, 83701, US

(21) Appl. No.: 09/859,144

(22) Filed: May 15, 2001

Related U.S. Application Data
(60) Provisional application No. 60/204,232, filed on May 15, 2000.

(51) Int. Cl. B61D 1/00; B60N 5/00

(52) U.S. Cl. 105/329.1; 105/355

(57) ABSTRACT

This invention is a freight and mass transit system which utilizes a road-rail adaptive vehicle. The adaptive vehicle is self-powered, and, with its power unit intact, is able to travel both on roads and on rails. In one embodiment, the adaptive vehicle loads easily and rides securely on a flat-bed type rail car. In another embodiment, the wheels or axles of the vehicle adapt to cooperate with the rail-line rails for traction and guidance, and the vehicle rides directly on the rails. Preferably, the rail version of the adaptive vehicle is connectable with other similar vehicles, so that a set of adaptive vehicles may travel like a train down the rails. Also, preferably, the rail version of the adaptive vehicle is connectable with the freight and passenger compartments of other similar vehicles, so that passengers may move from one adaptive vehicle to another in order to make their necessary travel connections during the rail transit.

This application claims priority of prior co-pending provisional application, Serial No. 60/204,232, filed May 15, 2001, which is hereby incorporated herein.

### BACKGROUND OF THE INVENTION

1. Field of the Invention.

This invention relates generally to transportation, and to freight transport and mass transit of humans. More specifically, this invention relates to a road-rail adaptive vehicle for freight and mass transit, and a freight and mass transit system utilizing such vehicle.

2. Related Art

Rail freight and transport of humans, of course, have been big businesses for a long time. Freight trains move millions of tons of goods a year. Passenger trains, both coast-to-coast long-distance travel type, and city-suburban commuter type, move millions of passengers every year. Still, these transit systems require huge capital investment in rail lines, rolling stock, terminals and personnel. Also, once established, these rail-line transit systems offer little flexibility, except for service schedule changes, in response to ridership load and location changes.

Also, road transport of freight and humans, of course, has been a big business for a long time. Passenger cars, trucks, vans and buses, both long-distance travel and short-haul commuter type, also move millions of tons of goods and millions of passengers every year. Still, for private cars, trucks and vans, the congestion, noise and air pollution from the very many vehicles required is a major drawback, especially in crowded urban or environmentally sensitive areas. Also, for public van and bus transit systems, these congestion, noise and air pollution problems persist.

Some prior patents which relate to road-rail adaptive vehicles are:

| | | | |
|---|---|---|---|
| 1. | U. S. Pat. No. 1,581,745 | Kellett | Transportation System |
| 2. | U. S. Pat. No. 3,051,098 | Gutridge | Apparatus For Handling |
| | | | Freight |
| 3. | U. S. Pat. No. 5,651,656 | Hapeman | Rail Transportable Ramps |
| | | | for Loading Semi-Trailers |
| | | | on Trains |
| 4. | U. S. Pat. No. 5,802,983 | Manzini | Railroad Platform Cart |
| 5. | European Patent #507/2/B/ | Anderegg | Road-Rail Transport |
| | | | System |

Still, there remains a need for an economical and efficient road-rail freight and mass transit system which helps reduce congestion, noise and air pollution. This invention addresses that need.

### SUMMARY OF THE INVENTION

This invention is a freight and mass transit system which utilizes a road-rail adaptive vehicle. The adaptive vehicle is self-powered, and with its power unit intact, is able to travel both on roads and on rails. While on the roads, the adaptive vehicle is able to drop off and pick up passengers at scattered locations, or according to a route, on streets, roads and highways. Then, the road version of the adaptive vehicle returns to a rail-line connection. There, the vehicle adapts to its rail version. In one embodiment, the adaptive vehicle loads easily and rides securely on a flat-bed type rail car. In another embodiment, the wheels or axles of the vehicle adapt to cooperate with the rail-line rails for traction and guidance, and the adaptive vehicle rides directly on the rails. Preferably, the rail version of the adaptive vehicle is connectable with other similar vehicles, so that a set of adaptive vehicles may travel like a train down the rails. This way, redundant power systems may be shut down in order to save fuel or utilities during the rail transit. Also, preferably, the freight or passenger compartment of the rail version of the adaptive vehicle is connectable with the compartments of other similar vehicles, so that freight and/or passengers may move from one adaptive vehicle to another in order to make the necessary travel connections during the rail transit. This way, when the rail portion of the transit is completed, the freight and/or passengers will already be transferred into the correct adaptive vehicle for the continued commute to the intended destination.

### BRIEF DESCRIPTION OF THE DRAWINGS

FIG. 1 is a schematic top-view diagram of one embodiment of a freight and mass transit system according to the present invention.

FIG. 2 is a schematic side-view diagram of an adaptive road-rail vehicle according to one embodiment of the present invention.

FIG. 3 is a schematic side-view diagram of another adaptive road-rail vehicle according to another embodiment of the present invention.

FIG. 4 is a schematic front-view diagram of one embodiment of an adaptive axle-wheel system in the rail mode according to the embodiment of the invention depicted in FIG. 3.

FIG. 5 is a schematic front-view diagram of one embodiment of an adaptive axle-wheel system in the road mode according to the embodiment of the invention depicted in FIG. 3.

### DETAILED DESCRIPTION OF THE INVENTION

Referring to the Figures, there are depicted several, but not all, embodiments of the present invention.

In FIG. 1, there is depicted an overview of one embodiment of a freight and mass transit system 10 according to the present invention. One rail-line route 11 between a city 12 and a suburb 14 is depicted. In the suburb 14, for a public passenger system, for example, there is a network of suburban bus routes 16. According to the invention, in the morning, for example, adaptive vehicles in the road mode traverse the suburban bus routes 16, picking up passengers. These adaptive vehicles then converge on a road-rail connection 18 in the suburb 14, and adapt to rail mode for the commute to the city 12. Preferably, on the rail line route 11, the passenger compartments of the adaptive vehicles are interconnected so passengers can move from one vehicle to another. This way, transfers from, for example, bus #1 (from suburban route #1), to, for example, bus #2 (for city route #2) may be made while the adaptive vehicles are in transit in the rail mode, saving commuting time and eliminating the need for a suburban terminal and a city terminal as well.

The adaptive vehicle's wheels for the rail transportation mode can be sized and spaced on their individual axles and suspension systems to fit and function on the several different rail gauges that exist throughout the international rail transportation infrastructure and which, in most applications, are commonly referred to as “Standard Gauge, Narrow Gauge, or Wide Gauge”.

During the rail mode transit, the adaptive vehicles preferably interconnect and are towed or pushed along the rails in train-like fashion. This way, the power drive units of the vehicles may be shut down in order to save on fuel or utilities, and to minimize noise and air pollution. Necessary or convenient connections to utilities for lighting, heating, ventilation and air conditioning may be provided for the adaptive vehicle “train” by the towing or pushing vehicle. In one embodiment of the invention, the towing or pushing vehicle itself may be one of the adaptive vehicles.

Upon arrival at the city connection 20, the adaptive vehicles disconnect from one another, convert to road mode, and depart to traverse the city routes 22, dropping off passengers. This way, the adaptive vehicles which pick up the very many commuting passengers in the suburbs end up, after the commute, in the city where they may be utilized to help the city's transit system during the day. Also, this way, by regional sharing of resources, the suburban transit system need not be burdened with the cost of a large number of vehicles needed during only a small part of the day.

In the evening, this process may be reversed for the going-home commute.

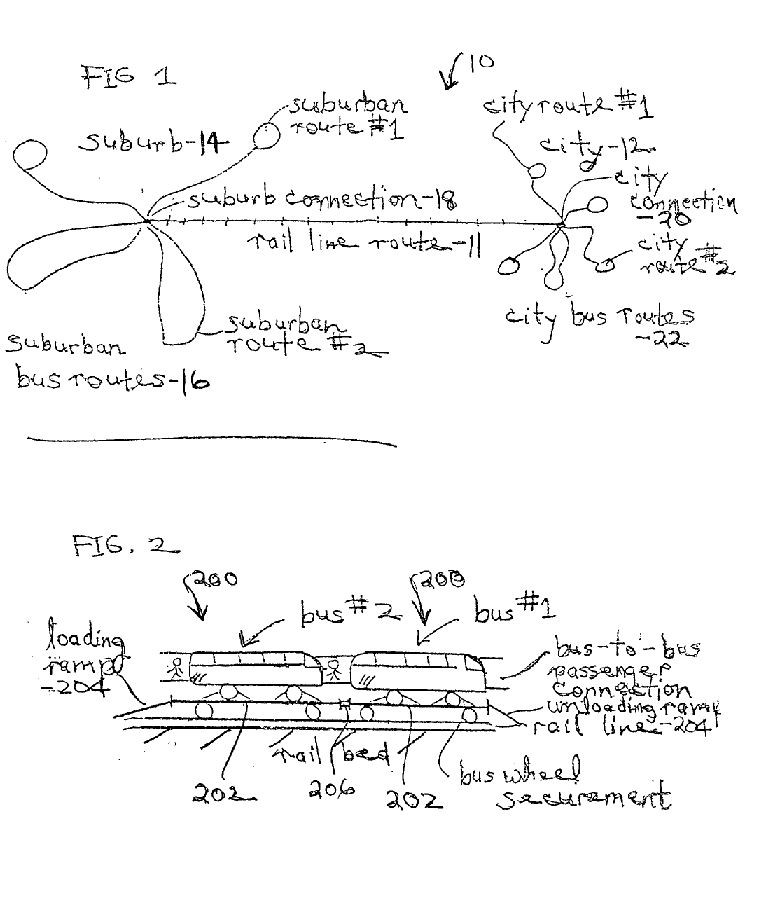

In FIG. 2, there is depicted one embodiment 200 of the adaptive vehicle of the invention which loads and is secured onto a flat-bed type rail car 202. Loading and unloading ramps 204 are provided at the end of the flat-bed rail car train so that the adaptive vehicles can drive onto and off of the train. Extendable ramps 206 are provided between the rail cars so that the adaptive vehicles can drive on the train from the back to the front to be secured at the next available space. The adaptive vehicles' wheels or frames are secured to the rail cars for stability and safety. In this embodiment, loading the adaptive vehicles is the conversion process from road to rail modes. Unloading the adaptive vehicles, converting from rail to road modes, may be done by driving the adaptive vehicles off the front of the rail cars. In this case the front tow vehicle may need to be removed, or loading and unloading ramps 204 may be required to extend onto/off of the flat-bed car/train at an angle or be able to pivot to do so.

Just before or during the rail transit, the passenger compartments of the adaptive vehicles may be interconnected. This way, passengers can transfer from one adaptive vehicle to another during the rail transit. This interconnection may be made, for example, by an extendable, covered walkway interconnecting the front of one adaptive vehicle to the back of another. Some flexibility may be required in the covered walkway to accommodate relative motion between the adjoining rail cars. During the transfer process, the adaptive vehicle drivers may serve as fare persons, conductors and stewards for the rail transit.

Other passenger compartment interconnections may also be made. For example, the flat-bed type rail car may be customized to have its own passenger interconnection, and receive, or “dock with” the loaded adaptive vehicle, and with the adjoining rail cars and their adaptive vehicle loads. In this embodiment, the passenger compartment interconnection is part of the rail car, demanding less weight and complexity in the adaptive vehicle.

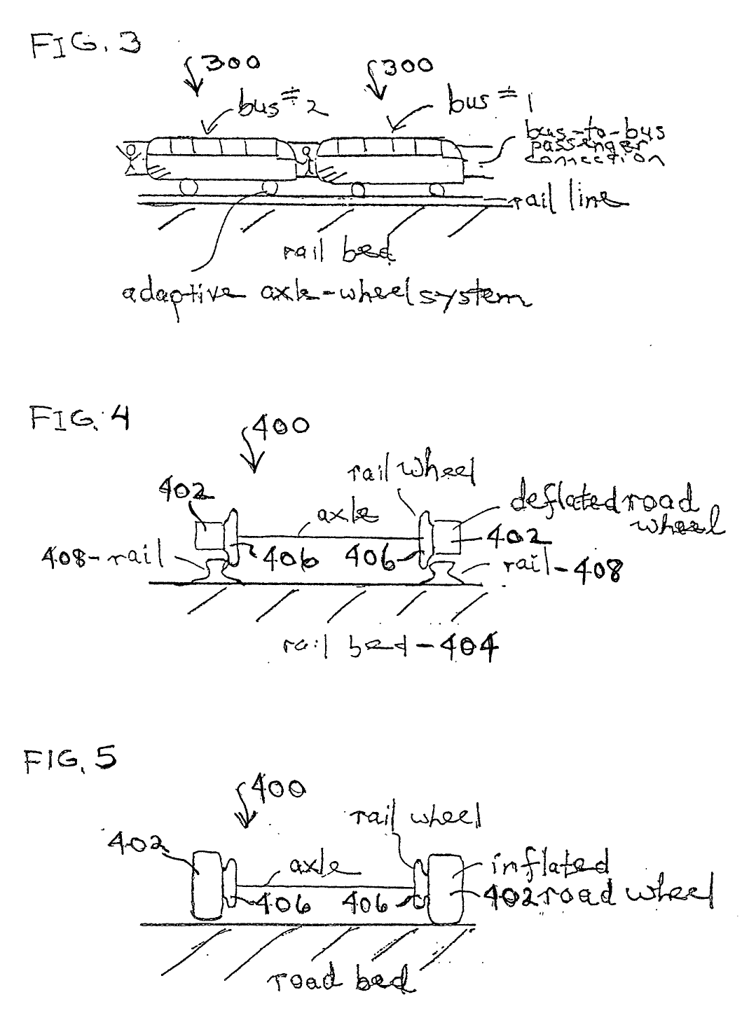

In FIG. 3 there is depicted another embodiment of the adaptive road-rail vehicle 300 of the invention. In this embodiment, the adaptive vehicle 300 has an adaptive axle-wheel system which permits it to ride both on roads and directly on rails. For example, the adaptive axle-wheel system may be a conventional conversion “bogie wheel” system presently found in railroad maintenance and repair vehicles. Preferably however, the adaptive axle-wheel system is a more novel, less complex and lighter technology. For example, according to FIGS. 4 and 5, there is depicted an adaptive axle-wheel system 400 wherein the drive wheels and steering wheels of the adaptive vehicles have remotely inflatable/deflatable road tires 402. According to this technology, when the road tires are inflated, they expand to support the weight of the adaptive vehicle on the road 404 (see FIG. 5), which rail wheels 406 then support the weight of the adaptive vehicle on the rails 408 (see FIG. 4).

It is envisioned that the 20-55 passenger adaptive vehicles will resemble buses in their seating arrangements, each with a center aisle, but with a rail coupling (potentially employing an automated coupling system) and a vestibule front and back for linking the adaptive vehicles while on rail and for allowing passengers to pass between adaptive vehicles.

The adaptive vehicles may also have applications for freight cargo transport (in bulk or individual packages) for local or regional delivery. Additional applications include hazardous materials transport, and troop and material transport for defense clients.

A long-haul ramp loading and carrier system would be beneficial for travel distances of, for example, forty miles or more when less fuel consumption, less air emissions, higher speeds, and enhanced passenger safety, security, and passenger comforts (e.g., dining cars, bathrooms, sleepers, etc.) would be desirable.

The long-haul ramp loading and carrier system features rail-wagons with self-leveling hinged hydraulic ramps to accommodate both front and rear loading of “drive-on/drive-off” road-rail buses. The road-rail buses are automatically locked, secured and electrically connected to an external power source to run the on-board HVAC systems, etc. The on-board engine for the road-rail bus is then shut down. The front and rear ramps automatically level out and lock in place to become part of the cargo bed supporting the road-rail bus. Retractable side loading ramps extend out at 90° angles from the appropriate side of the front and/or rear loading ramp to facilitate the safe loading of the road-rail bus. This is particularly important in confined areas where the road-rail bus does not have the certainty for entry from an 180° position that would be perfectly in-line with the ramp-loading bus's automatic tire inflation/deflation system. Each rail-wagon's load-carrying surface might feature rails on which the bus's rail wheels would seat upon deflation of the pneumatic road tires; the bus could then be locked and secured in the rail-mounted position on the rail-wagon.

The ramp-loading and carrier system also features a hydraulically operated extendable and/or retractable bed. This feature offers the opportunity to make the adjustments necessary in order to accommodate road-rail buses of differing sizes, lengths and quantities, thereby affording greater safety and efficiencies to the road-rail system. Once underway, passengers would be able to freely move between the road-rail buses and road-rail carrier(s) by means of interconnecting, handicapped-accessible vestibules. This would afford all passengers the ability to easily move to the correct road-rail bus for their destination, or to a dining car, etc.

The automatic tire inflation/deflation system can also provide for a more efficient vehicle suspension design that features a pair of road wheels and a pair of rail wheels mounted onto a single unified axle assembly, and rotating about a single axis. The axle assembly can be adjusted geometrically to assure free and uninterrupted clearance for the road wheels during the rail transportation mode, and to assure free and uninterrupted clearance for the rail wheels during the road transportation mode.

This system also has application for the road-rail vehicle conversion industry (e.g. for Suburbans™, Sport Utility Vehicles (“SUVs”), pickups, or other heavy-duty utility and service vehicles and equipment).

This novel adaptive axle-wheel system features a unified tire (road)/wheel (rail) combination on one axle assembly. This employs an active rail application on a rail alignment flanging device, to both hold the adaptive vehicle on the rail on straight and curved track and act as a rail wheel, resulting in minimized maintenance on a life-cycle basis. This can employ an inflate-deflate feature, or a solid or foam road wheel.

Although this invention has been described above with reference to particular means, materials and embodiments, it is to be understood that the invention is not limited to these disclosed particulars, but extends instead to all equivalents within the scope of the following claims.

We claim:

1. A transportation system for freight and/or passengers, comprising:
a. a road system;
b. a rail system;
c. a plurality of road-rail adaptive vehicles, each of said vehicles being self-powered and adapted to travel both on said road system in a road mode and on said rail system in a rail mode;
wherein said adaptive vehicles in rail mode are connectable with other adaptive vehicles in rail mode, so that a set of adaptive vehicles may travel down the rails like a train.

2. The transportation system of claim I wherein the adaptive vehicles have a freight and/or passenger compartment which is connectable with the freight and/or passenger compartment of other adaptive vehicles, so that freight and/or passengers may be moved from one adaptive vehicle to another during the rail transit.

3. The transportation system of claim 1 wherein the adaptive vehicles convert from road mode to rail mode by loading and riding on a flat-bed type rail car.

4. The transportation system of claim 1 wherein the adaptive vehicles convert from road mode to rail mode by deflating road tires so that rail wheels become positioned to cooperate with the rail system.

5. A road-rail adaptive vehicle comprising:
a self-powered vehicle adapted to travel both on a road system in road mode and on a rail system in rail mode,
wherein said adaptive vehicle in rail mode is connectable to other adaptive vehicles in rail mode, so that a set of adaptive vehicles may travel down the rails like a train.

6. The adaptive vehicle of claim 5 which comprises a freight and/or passenger compartment which is connectable with the freight and/or passenger compartment of other adaptive vehicles, so that freight and/or passengers may be moved and/or may move from one adaptive vehicle to another during the rail transit.

7. The adaptive vehicle of claim 5 wherein the adaptive vehicle is adapted to convert from road mode to rail mode by loading and riding on a flat-bed type rail car.

8. The adaptive vehicle of claim 5 wherein the adaptive vehicle is adapted to convert from road mode to rail mode by deflating road tires so that rail wheels become positioned to cooperate with the rail system.

9. The adaptive vehicle of claim 8 comprising a plurality of combined tire-wheel units, each tire-wheel unit comprising a inflatable road tire closely adjacent to a rail-road wheel, and an inflation-deflation system adapted to inflate the road tire for road mode to an extent that the road tire extends beyond the rail-road wheel to contact the road system and adapted to deflate the road tire for rail mode to expose the rail-road wheel for contact with the rail system.

10. A road-rail adaptive vehicle comprising:
a self-powered vehicle adapted to travel both on a road system in road mode and on a rail system in rail mode;
wherein the adaptive vehicle is adapted to convert from road mode to rail mode by deflating road tires so that rail wheels become positioned to cooperate with the rail system.

11. The adaptive vehicle of claim 10 comprising a plurality of combined tire-wheel units, each tire-wheel unit comprising a inflatable road tire closely adjacent to a rail-road wheel, and an inflation-deflation system adapted to inflate the road tire for road mode to an extent that the road tire extends beyond the rail-road wheel to contact the road system and adapted to deflate the road tire for rail mode to expose the rail-road wheel for contact with the rail system.
